(19) United States
(12) Patent Application Publication
(10) Pub. No.: US 2019/0368222 A1
(43) Pub. Date: Dec. 5, 2019

(54) DOOR HANDLE

(71) Applicant: Rajesh Vinod Jethwa, Bishops Stortford, Hertfordshire (GB)

(72) Inventor: Rajesh Vinod Jethwa, Bishops Stortford, Hertfordshire (GB)

(21) Appl. No.: 16/341,528

(22) PCT Filed: Oct. 12, 2017
(86) PCT No.: PCT/GB2017/053090

§ 371 Date: Apr. 12, 2019

(30) Foreign Application Priority Data
Oct. 14, 2016 (GB) 1617465.8

(51) Int. Cl. E05B 13/10; E05B 15/04

(52) U.S. Cl. CPC E05B 13/101; E05B 2015/0431; E05B 15/04

(57) ABSTRACT

A handle for a door, window or other openable structure. A handle body 8 is rotatable about the axis of a spindle 14. A spindle-engaging part 2 is manually movable along the handle body 8 and into and out of engagement with the spindle 14. Thus, rotation of the handle body 8 causes rotation of the spindle only when the spindle-engaging part 2 engages the spindle 14. A catch 24 retains the spindle-engaging part 2 in its engaged position.

### BACKGROUND TO THE INVENTION

This invention relates to a door or window handle.

A known uPVC door has a handle at adult waist height. This is within the reach of a child who can open the door. In the case of a front door of a house this causes safety and security issues.

It is possible to lock the door to prevent a child from opening it. This may then cause a safety issue of its own where the door must be available as a fire exit.

US 2001/0030427 describes a child safety handle which can only open the door when a user slides a control element along the handle as well as rotating the handle. However the child safety feature may not be required at all times, and this known handle does not allow operation without it. Another problem is that different households include children of different ages, some of whom may be trusted to use a door or window, but may not be able to operate the known handle.

### SUMMARY OF THE INVENTION

The invention consists in a handle for a door, window or other openable structure, the handle comprising:
a spindle having an axis,
a handle body rotatable about the axis of the spindle,
a spindle engaging part manually movable along the handle body and into and out of engagement with the spindle, such that rotation of the handle member causes rotation of the spindle only when the spindle engaging part engages the spindle, and
a catch for retaining the spindle engaging part in its engaged position.

The catch may have a projection that impedes the motion of the spindle engaging member away from the spindle, when the catch has been set to allow conventional handle operation. This projection may interfere with an abutment on the spindle engaging member. The catch may have a manually operable part extending on one side of the handle body.

A biasing means such as an extension spring may be provided for returning the spindle engaging part to the position in which it does not engage the spindle. The force exerted by the biasing means may be adjustable.

The invention also provides a handle for a door, window or other openable structure, the handle comprising:
a spindle having an axis,
a handle body rotatable about the axis of the spindle,
a spindle engaging part manually movable along the handle body and into and out of engagement with the spindle, such that rotation of the handle member causes rotation of the spindle only when the spindle engaging part engages the spindle, and
a biasing means for returning the spindle engaging part to the position in which it does not engage the spindle, wherein the force exerted by the biasing means is adjustable.

The biasing means may comprise an extension spring and the distance between a distal end of the spring and the spindle engaging part can be adjustable. A worm gear may be provided for moving an anchor for the spring to effect such adjustment.

The spindle engaging part can comprise an internal plate slidable within the handle body and having an end formation engageable with the spindle. The spindle engaging part can further comprise an external plate or button slidable on an outer side of the handle body, for example by the thumb of a user's hand which is holding the handle, and connected to and controlling the internal plate.

The biasing means, which may be an extension spring, may have an end further from the spindle which can be moved towards and away from the spindle engaging part. A worm gear may be provided for moving an anchor for the spring to effect such adjustment.

The handle may comprise a cam, connected to the spindle and arranged to rotate the spindle, and a cam engaging member attached to a housing of the handle, the cam engaging member being arranged to rotate the cam and the spindle when the handle is moved upwardly but not downwardly. In this way, deadlocking of the door can be achieved in a conventional manner without requiring operation of the spindle engaging part.

### BRIEF DESCRIPTION OF THE DRAWINGS

An embodiment of the invention will now be described in more detail, by way of example only, with respect to the accompanying drawings, in which:

FIG. 1 is a front view of a spindle engaging part in the disengaged position;

FIG. 2 is a rear view of the spindle engaging part in the disengaged position;

FIG. 3 is a side view of the spindle engaging part in the disengaged position;

FIG. 4 is a perspective view the spindle engaging part in the disengaged position, showing a part of the handle housing;

FIG. 5 is a rear view of the spindle engaging part in the engaged position, showing a part of the handle housing;

FIG. 6 is a rear perspective view of the spindle engaging part, also showing the catch in its enabling position;

FIG. 7 is a view similar to FIG. 6, but also showing the rear part of the handle housing;

FIG. 8 is a side view of the spindle engaging part, showing the catch in its disabling position;

FIG. 9 is a rear perspective view of the spindle engaging part, also showing the catch in its disabling position;

FIG. 10 is a rear view of the interior of the handle, showing the cam, in a raised position;

FIG. 11 is a rear view of the interior of the handle, showing the cam, in a lowered position;

FIG. 12 is a side view of the spindle engaging part, showing the spring adjusted for minimum tension;

FIG. 13 is a rear perspective view of the spindle engaging part in the minimum tension position, also showing the rear of the housing; and

FIG. 14 is a side view of the spindle engaging part, showing the spring adjusted for maximum tension.

### DETAILED DESCRIPTION OF PARTICULAR EMBODIMENTS

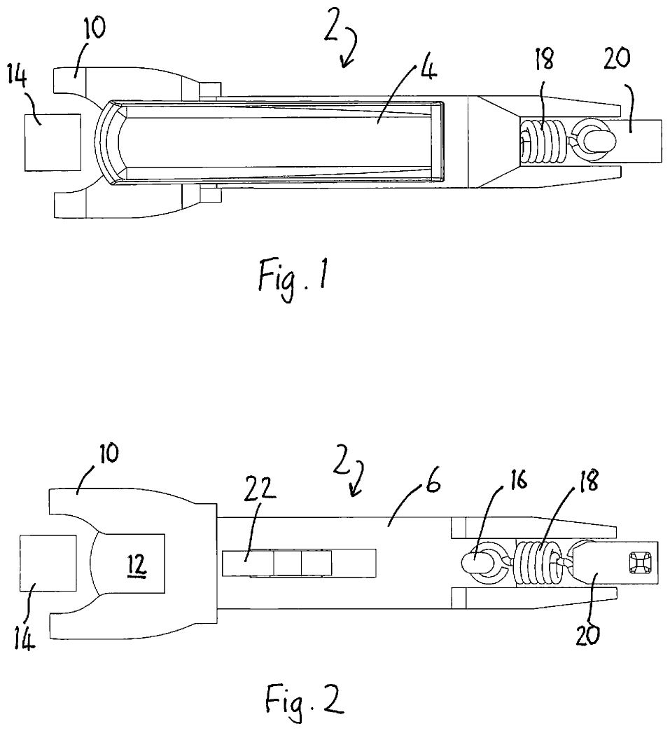

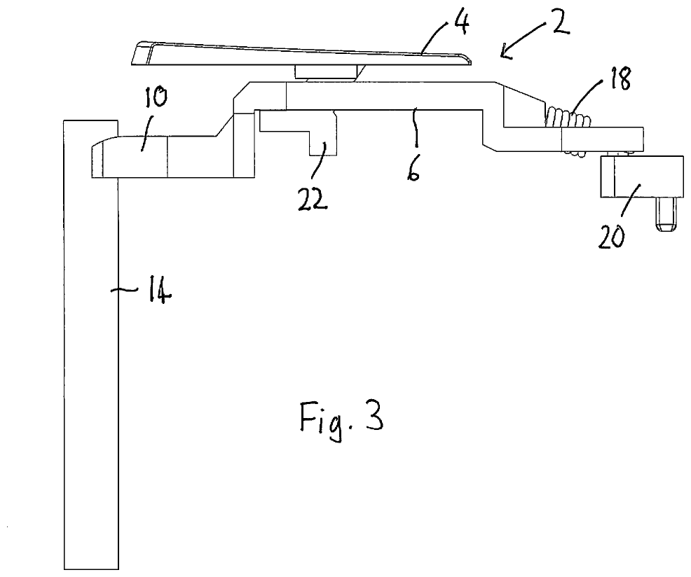

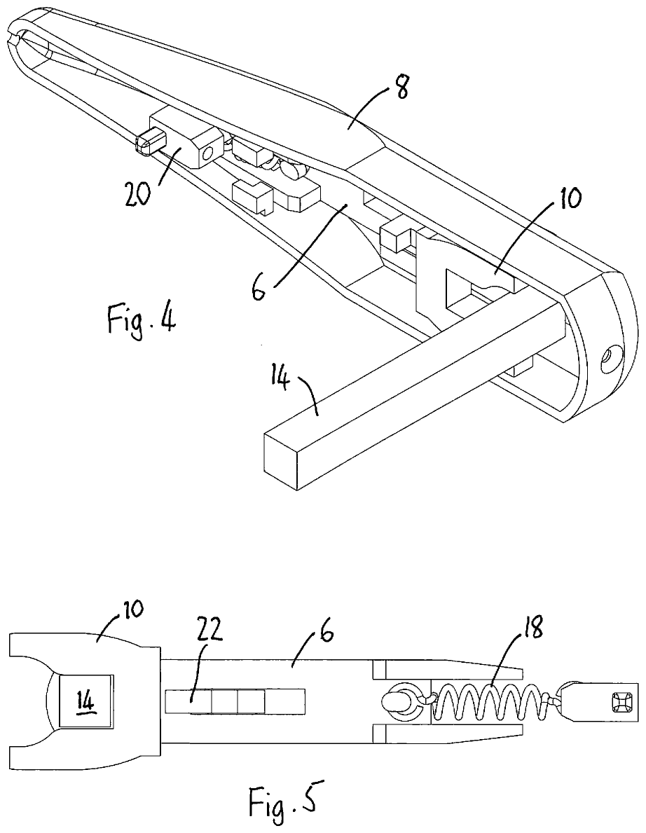

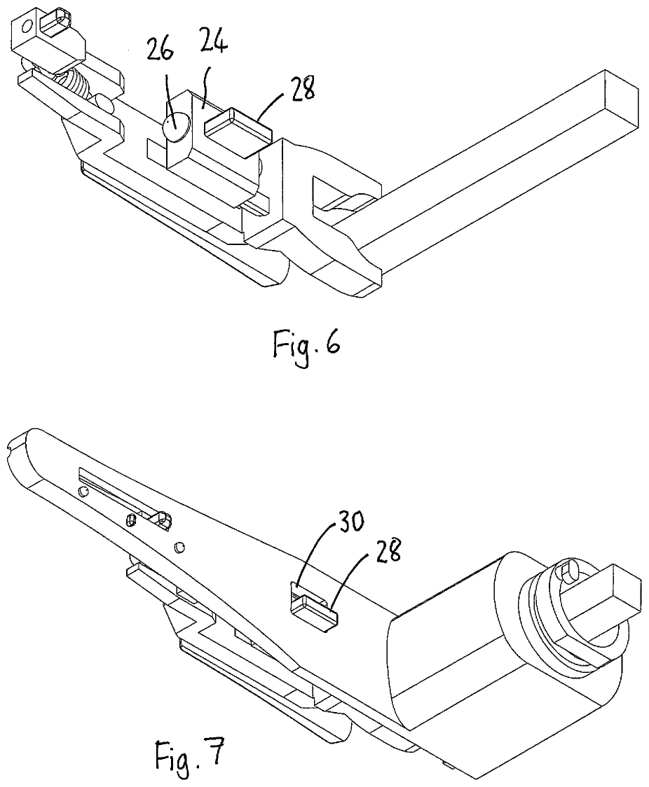

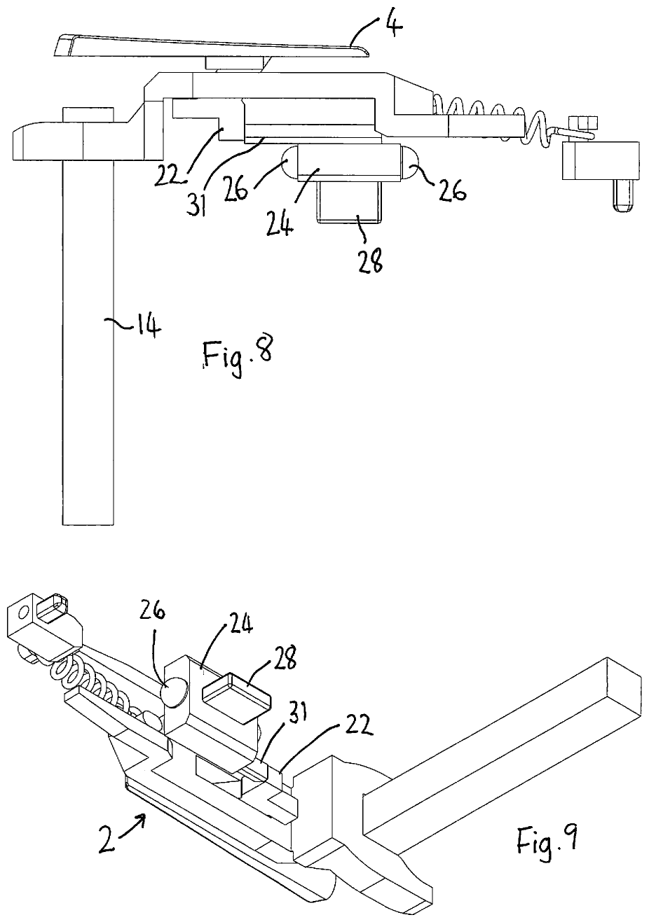

FIGS. 1 to 5 show a door handle within which a spindle engaging part 2 can slide. The spindle engaging part includes an elongate thumb pad 4 and an internal plate 6, which parts are mutually connected through a slot in a housing 8 of the handle.

A spindle end of the internal plate 6 terminates in jaws 10 which define a square shaped recess 12 of a size corresponding to the square section spindle 14.

A distal end of the internal plate 6 carries a peg 16 to which one end of an extension spring 18 is attached. The other end of the spring 18 is attached to an anchor 20. In its unstressed state the spring 18 keeps the spindle engaging part 2 in the position shown in FIGS. 1 to 4.

An L-shaped prong 22 is fixed to the inner side of the internal plate 6.

A user wishing to open the door grasps the handle and uses his or her thumb to slide the thumb pad 4 to the right as viewed in FIGS. 1, 2 and 3. This moves the spindle engaging part against the force of the spring to the position shown in FIG. 5 in which the jaws 10 engage the spindle 14. Subsequent rotation of the handle will rotate the spindle 14 enabling the door to be opened. A child will not be able to perform the sliding of the spindle engaging part and will not be able to open the door.

FIGS. 6 to 9 show a catch 24 which is movable upwardly and downwardly on bearings 26, by means of an extension 28 that extends through an aperture 30 in the rear part of a handle hosing. When the catch 24 is in its lower position, shown in FIGS. 6 and 7, the handle operates in the manner described above.

If the thumb pad 4 is used to move the spindle engaging part 2 to the engaged position, and the catch 24 is then moved upwardly, a projection 31 on the catch 24 blocks the L-shaped prong 22 so that the spindle engaging part will remain in the engaged position shown in FIGS. 8 and 9, even when the thumb pad 4 is released. In this way, the handle can be set to be used as a conventional handle with none of the security features active. This is a useful feature in households where the security features are not required at all, or if the security features need to be temporarily disabled, for example for the benefit of visitors needing to use the door.

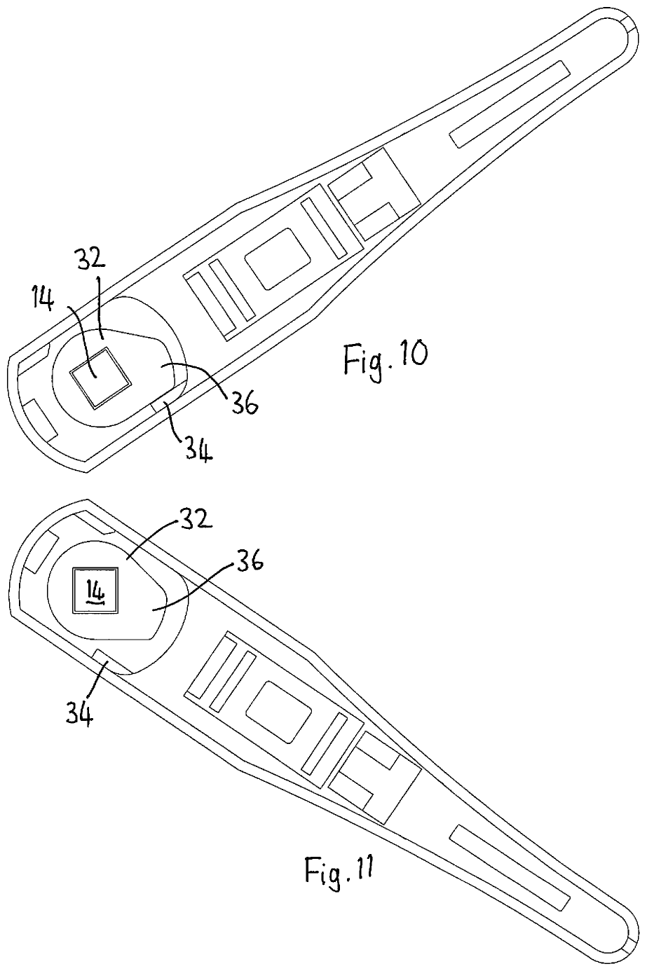

FIG. 10 shows a cam 32 which is carried by the spindle 14 so as to rotate the latter. A cam engaging member 34 on the handle housing abuts a lobe 36 of the cam 32. Thus, when the handle is moved to the raised position shown, the spindle 14 is rotated even if the spindle engaging part 2 is not engaged. This means that the door can easily be deadlocked by raising the handle. But if the handle is moved downwardly to the position shown in FIG. 11, the cam 32 and the spindle 14 are not rotated of the spindle engaging part 2 is not engaged.

FIGS. 12 to 14 show how the tension in the spring 18 can be adjusted. The anchor 20 comprises a block 38 having a threaded bore which is carried on a threaded rod 40. A distal end of the rod 40 has a slot 42 which is accessible through an aperture in the end of the handle housing. A screwdriver inserted into the slot 42 can be used to rotate the rod 40 and cause the anchor 20 to move towards and away from the spindle engaging part 2. This movement is guided by a lug 44 of the anchor which moves along a slot 46 in the housing.

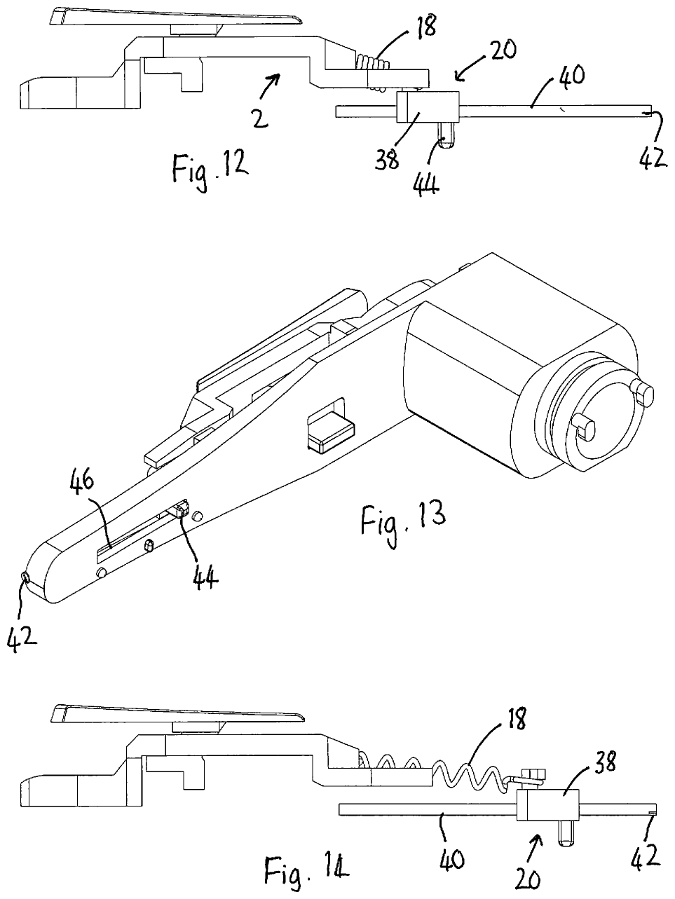

FIGS. 12 and 13 show the minimum tension position in which the anchor 20 is at its position closest to the spindle engaging part 2, whilst FIG. 14 shows the maximum tension position.

This feature is useful for households as where infants are present, in which case the tension can be set to minimum as it is unlikely infants will have the motor skills to successively slide the thumb plate 4 and then depress the handle in order to open the door. For households with older children, the tension can be increased so that whilst the child may have adequate intelligence, he/she is unable to open the door as he/she does not possess the required strength to slide the thumb plate 4 across.

The handle and its components can be made from a metallic material such as aluminium. The thumb pad 4 and catch extension 28 can be made from or covered with a softer material.

The handle of the invention can be easily and quickly installed. It is effective in preventing children from opening a door without requiring the door to be locked. Thus in the event of a fire or other emergency, the door can still be easily opened.

Burglars can attempt to open a door by inserting a wire or stick through the letterbox in order to pull the door handle down. The handle of the invention thwarts such attempts as merely pulling the handle down does not open the door.

The handle of invention is applicable to a door, a window or another openable structure such as a drawer.

1. A handle for a door, window or other openable structure, the handle comprising:
a spindle having an axis,
a handle body rotatable about the axis of the spindle,
a spindle engaging part manually movable along the handle body and into and out of engagement with the spindle, such that rotation of the handle body causes rotation of the spindle only when the spindle engaging part engages the spindle; and
a catch for retaining the spindle engaging part in its engaged position.

2. A handle according to claim 1, wherein the catch has a projection that impedes the motion of the spindle engaging member away from the spindle.

3. A handle according to claim 2, wherein the projection interferes with an abutment on the spindle engaging member.

4. A handle according to claim 1, wherein the catch has a manually operable part extending on one side of the handle body.

5. A handle according to claim 1, comprising a biasing means for returning the spindle engaging part to the position in which it does not engage the spindle.

6. A handle according to claim 5, wherein the force exerted by the biasing means is adjustable.

7. A handle for a door, window or other openable structure, the handle comprising:
a spindle having an axis,
a handle body rotatable about the axis of the spindle,
a spindle engaging part manually movable along the handle body and into and out of engagement with the spindle, such that rotation of the handle member causes rotation of the spindle only when the spindle engaging part engages the spindle, and
a biasing means for returning the spindle engaging part to the position in which it does not engage the spindle, wherein the force exerted by the biasing means is adjustable.

8. A handle according to claim 7, wherein the biasing means comprises an extension spring.

9. A handle according to claim 8, wherein the distance of a distal end of the spring from the spindle engaging part is adjustable.

10. A handle according to claim 9, comprising a worm gear for moving an anchor for the spring.

11. A handle according to claim 1, wherein the spindle engaging part comprises an internal plate slidable within the handle body and having an end formation engageable with the spindle.

12. A handle according to claim 11, wherein the spindle engaging part comprises an external member slidable on a surface of the handle body, and connected to and controlling the internal plate.

13. A handle according to claim 12, wherein the external member is slidable by the thumb of a user's hand which is holding the handle.

14. A handle according to claim 12, wherein said surface of the handle body is opposite said one side.

15. A handle according to claim 1, comprising a cam, connected to the spindle and arranged to rotate the spindle, and a cam engaging member attached to the handle body, the cam engaging member being arranged to rotate the cam and the spindle when the handle is moved upwardly but not downwardly.

16. A handle according to claim 4, wherein said surface of the handle body is opposite said one side.

17. A handle according to claim 5, wherein the biasing means comprises an extension spring.

18. A handle according to claim 17, wherein the distance of a distal end of the spring from the spindle engaging part is adjustable.

19. A handle according to claim 18, comprising a worm gear for moving an anchor for the spring.

20. A handle according to claim 7, wherein the spindle engaging part comprises an internal plate slidable within the handle body and having an end formation engageable with the spindle.
